(19) United States
(12) Patent Application Publication
(10) Pub. No.: US 2025/0313459 A1
(43) Pub. Date: Oct. 9, 2025

(54) HALOGEN MEDIATED PRODUCTION OF HYDROGEN AND CARBON FROM HYDROCARBONS

(71) Applicant: The Regents of the University of California, Oakland, CA (US)

(72) Inventors: Eric W. McFarland, Santa Barbara, CA (US); Ji Qi, Santa Barbara, CA (US)

(73) Assignee: The Regents of the University of California, Oakland, CA (US)

(21) Appl. No.: 18/865,462

(22) PCT Filed: May 12, 2023
(86) PCT No.: PCT/US2023/066952

§ 371 Date: Nov. 13, 2024

Related U.S. Application Data
(60) Provisional application No. 63/341,752, filed on May 13, 2022.

(51) Int. Cl. C01B 3/26; C01B 7/01; C01B 7/09; C25B 1/24; C25B 15/08

(52) U.S. Cl. CPC C01B 3/26; C01B 7/01; C01B 7/093; C25B 1/24; C25B 15/081; C01B 2203/0277; C01B 2203/1241

(57) ABSTRACT

A process for producing hydrogen from feedstocks containing hydrogen and carbon includes contacting a hydrocarbon feedstock with a reactant containing a halogen in a reactor to produce hydrogen, hydrogen halide, and a solid product that includes carbon, regenerating the halogen from the hydrogen halide; and separating the hydrogen as a product.

### CROSS-REFERENCE TO RELATED APPLICATIONS

This application claims priority to U.S. Provisional Application No. 63/341,752 filed on May 13, 2022 and entitled, “Halogen Mediated Production of Hydrogen and Carbon from Hydrocarbons,” which is incorporated herein by reference in its entirety.

### STATEMENT REGARDING GOVERNMENTALLY SPONSORED RESEARCH OR DEVELOPMENT

None.

### BACKGROUND

The transformation of chemical feedstocks such as hydrocarbons into products such as carbon and hydrogen can require significant amounts of energy as well as relying on reactors with severe operating conditions. Conversion of hydrocarbon feedstocks such as natural gas containing methane with strong carbon-hydrogen bonds is particularly challenging and typically utilizes reactors containing catalysts and/or making use of high temperatures. For reversible reactions, equilibrium limitations, can also make very high temperatures desirable but limited by reactor material considerations.

### SUMMARY

In some embodiments, a process for producing hydrogen from feedstocks containing hydrogen and carbon comprising contacting a hydrocarbon feedstock with a reactant containing a halogen in a reactor to produce hydrogen, hydrogen halide, and a solid product that comprises carbon, regenerating the halogen from the hydrogen halide, and separating the hydrogen as a product.

In some embodiments, a pyrolysis system using a halogen comprises a reactor, a halogen regeneration unit, and a recycle line fluidly coupling the reactor and the halogen regeneration unit configured to pass at least a portion of the halogen from the halogen regeneration unit to the reactor. The reactor is configured to contact a hydrocarbon feedstock with a reactant containing a halogen to produce hydrogen, hydrogen halide, and a solid product, wherein the solid product comprises carbon. The halogen regeneration unit is configured to receive at least a portion of the hydrogen halide from the reactor and generate the halogen.

In some embodiments, a reaction process comprises introducing a hydrocarbon feedstock into a reactor countercurrent to a moving bed of solid material moving through a reaction zone in the reactor, introducing a halogen into the feedstock within the reactor to contact the halogen with the hydrocarbon feedstock, producing solid products, hydrogen, and hydrogen halide in response to contacting the halogen with the hydrocarbon feedstock, depositing the solid products on the moving bed of the solid material, and passing the hydrogen and hydrogen halide out of the reactor.

In some embodiments, a reaction process comprises passing a mixture of a hydrocarbon feedstock and a halogen through a first reactor bed, producing hydrogen, hydrogen halide, and a solid product within the first reactor bed where the solid product deposits in the first reactor bed, passing the hydrogen and the hydrogen halide through a second reactor bed, heating the second reactor bed with the hydrogen and hydrogen halide, and passing the hydrogen and hydrogen halide to a separator.

In some embodiments, a process of recovering hydrogen from a subterranean formation comprises injecting a halogen into a subterranean formation that comprises a hydrocarbon, contacting the halogen with the hydrocarbon in the subterranean formation, producing hydrogen, hydrogen halide, and a solid product that comprises carbon, depositing the carbon in the subterranean formation, and recovering the hydrogen and hydrogen halide from the subterranean formation.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIGS. 1A and 1B schematically illustrate integrated continuous processes using a halogen co-fed with a hydrocarbon feedstock to produce hydrogen and hydrogen halide and solid carbon with the hydrogen halide processed to regenerate the halogen and hydrogen.

FIGS. 2A, 2B, and 2C schematically illustrate integrated continuous processes using a halogen co-fed with a hydrocarbon feedstock to produce hydrogen and hydrogen halide and solid carbon. Hydrogen is separated and the hydrogen halide is reacted with oxygen to regenerate the halogen producing water.

FIG. 3 schematically illustrates a process for the halogen mediated pyrolysis of a hydrocarbon with energy storage.

FIG. 4 schematically illustrates a process for the halogen mediated pyrolysis of a hydrocarbon using a semi-batch rotating bed.

FIG. 5 schematically illustrates a process for the halogen mediated pyrolysis of a hydrocarbon with associated hydrocarbon separation and value-added product production.

FIG. 6 schematically illustrates another process for the halogen mediated pyrolysis of a hydrocarbon with associated hydrocarbon separation and value-added product production.

FIG. 7 schematically illustrates a process for the halogen mediated pyrolysis of a hydrocarbon within a subterranean formation.

FIG. 8 schematically illustrates a process for the halogen mediated pyrolysis of a hydrocarbon according to some embodiments.

FIG. 9 schematically illustrates another process for the halogen mediated pyrolysis of a hydrocarbon according to some embodiments.

FIG. 10 schematically illustrates still another process for the halogen mediated pyrolysis of a hydrocarbon according to some embodiments.

FIG. 11 schematically illustrates a reactor configuration for the halogen mediated pyrolysis of a hydrocarbon according to some embodiments.

FIG. 12 schematically illustrates another reactor configuration for the halogen mediated pyrolysis of a hydrocarbon according to some embodiments.

FIG. 13 shows methane conversion as determined in Example 1.

FIG. 14 shows methane conversion as determined in Example 4.

FIG. 15 shows a schematic of a laboratory configuration for a reactor as described in Example 6.

### DETAILED DESCRIPTION

As used herein, the following definitions will apply:

Autothermal: Refers to a reaction or a system of reactions where an exothermic reaction and an endothermic reaction are simultaneously conducted such that the overall reaction requires no energy input once the reaction is initiated.

Reactant: Any substance that enters into and is potentially altered in the course of a chemical transformation.

Product: A substance resulting from a set of conditions in a chemical or physical transformation.

Reactor: A container or apparatus in which substances are made to undergo chemical transformations.

Halogen: Oxidant molecule from the group including bromine, chlorine, iodine, fluorine.

Condensed Phase: A liquid and/or solid.

Natural Gas: A collection of mostly methane with much smaller amounts of other light alkanes (ethane, propane, etc.) and trace impurities (CO₂, N₂, water, etc).

Pyrolysis: At least a partial decomposition of a hydrocarbon to solid carbon and hydrogen.

Dehydrohalogenation: Removal of a hydrogen halide from an atom or molecule.

Halogenation Compound: A compound containing one or more halogens that can react with a hydrocarbon and produce hydrogen halide (e.g. CCl₄).

Hydrocarbons: Any compounds comprising carbon and hydrogen, with or without heteroatoms present such as oxygen, nitrogen, sulfur, and the like.

The processes, systems, and methods disclosed herein demonstrate how molecular hydrogen production from decomposition of hydrocarbon feedstocks can be facilitated using halogens. Generally, hydrocarbon decomposition requires significant energy inputs at high temperature, which complicates reactor and process design. By operating in a halogen limited regime to produce both molecular hydrogen and hydrogen halides little or no heat needs to be added to the reactor and the process energy input is shifted to the hydrogen halide to halogen recovery step

Hydrogen is an important chemical intermediate and possibly a future fuel. The only practical feedstocks for the large-scale production of hydrogen are water, biomass, and fossil hydrocarbons. In all cases, hydrogen exists oxidized as H⁺¹ and thus electrons are required either through a concerted chemical oxidation or provided electrochemically. Water electrolysis can couple the reduction of H⁺¹ on a cathode surface with O⁻² oxidation on an anode using significant amounts of energy (60 kWh/kg H₂) in a capital intensive electrochemical cell. The overall reaction is shown below.

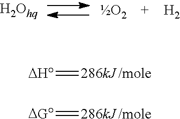

Hydrogen is also produced commercially primarily by reforming of hydrocarbons, typically methane, with steam (SMR) and use of the water-gas shift (WGS) process to maximize hydrogen. Steam must be produced from the liquid water with energy required to do so. The reactions are shown below.

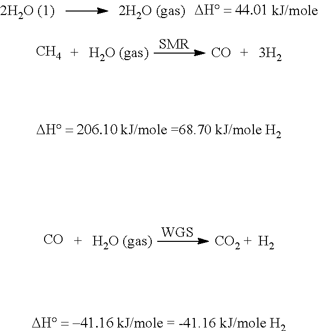

The overall reaction is endothermic, and reforming requires energy input to a reactor at high temperature, which is challenging. The overall hydrogen yield is high since half the hydrogen comes from water:

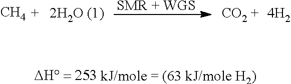

The need to add heat to the reactor can be eliminated by combining the large exothermic combusion of methane (−891 KJ/mole) with reforming in autothermal reforming (ATR) which produces one less hydrogen but requires no energy addition to the reactor (as shown in the following equation),

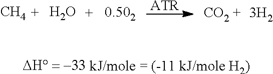

In the absence of a penalty for carbon dioxide, for most reasonable prices of methane from natural gas, there is no commercially competitive process alternatives to natural gas reforming with water. As greater attention is placed on carbon dioxide emissions reduction and a negative cost assigned to carbon dioxide the economics can change and alternative processes may compete.

Hydrocarbon decomposition (pyrolysis) is considered an alternative technology for hydrogen production. In methane pyrolysis, partial oxidation of carbon from C⁻⁴ to C⁰ occurs with simultaneous reduction of hydrogen from H⁺¹ to H⁰ in H₂,

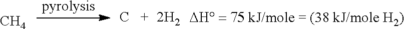

Methane pyrolysis produces readily sequestered solid carbon and requires less energy input per hydrogen produced than reforming, however, reforming can produce more hydrogen per methane molecule reacted because half the hydrogen comes from water. Whereas, steam methane reforming makes use of solid catalysts to increase the reaction rate at reasonable temperatures. In contrast, solid carbon is formed in pyrolysis, and use of solid catalysts is not practical.

An ideal autothermal process could theoretically utilize a minimal amount of oxygen to internally combust a portion of the hydrogen providing the reaction energy in the isothermal reaction,

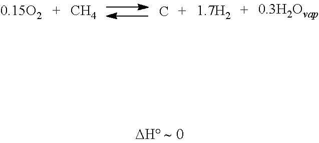

Unfortunately, it is not practical to react carbon containing species at high temperature without the production of carbon oxides.

The present systems and methods provide a novel approach to the ideal autothermal reaction and allow for the decomposition of methane or any other hydrocarbon autothermally without producing carbon oxides such as CO₂. Any suitable hydrocarbon can be used as a feedstock to the process including light hydrocarbons such as methane along with heavier hydrocarbons such as crude oil. For example, the feedstock can comprise one or more of a C₁-C₈ hydrocarbon (e.g., methane, ethane, propane, etc.), crude oil, vapors from petroleum, or any other suitable hydrocarbons.

The process uses an oxidant that cannot produce carbon oxides but facilitates the decomposition chemistry and eliminates the need for heat addition into a high temperature reactor. A preferred choice of oxidants are halogens, X₂, where X can include iodine, bromine, chlorine, and/or fluorine. The halogens can be provided in a variety of forms including element halogens, alkyl halides, metal halides, and/or hydrogen halides. For example, the halogen can be provided as one or more of the following: elemental halogens, fluorine, chlorine, bromine, iodine, alkyl halides including but not limited to methyl, ethyl, propyl bromides and/or chlorides, metal halides including but not limited to chlorides or bromides of carbon, iron, nickel, zinc, and cobalt, and the hydrogen halides include HF, HCl, HBr, and/or HI. With the proper amount of halogen added to the hydrocarbon (such as methane) the decomposition proceeds without energy addition at high temperatures, and the reaction produces solid carbon, hydrogen, and hydrogen halides. The fundamental decomposition reaction is facilitated by the radical mediated halogen reactions and can be operated at high pressures without heat addition to the reactor according to the following equation.

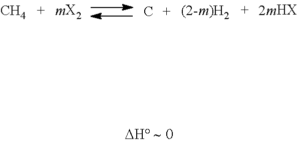

For use in a process, the halogen must be recovered and reused. One preferred embodiment for recovery of the halogen makes use of electrolysis of the hydrogen halide. Although a modest amount of energy is required, additional hydrogen is produced together with the halogen, and ideally, the energy required can be approximately that which would have been required for the pyrolysis reaction. For example, the recovery can be represented by the following equation:

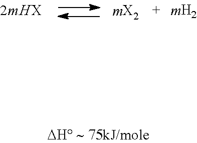

By comparison to water electrolysis which in practice requires approximately 60 kWh/kg H₂, the energy required for the electrochemical step to recover the halogen and produce hydrogen accounts for only approximately 6 kWh/kgH₂, a factor of 10 less energy. Further, since the fraction of hydrogen produced electrochemically can be small, the capital cost associated with the electrolyzer can be far less than for water electrolysis.

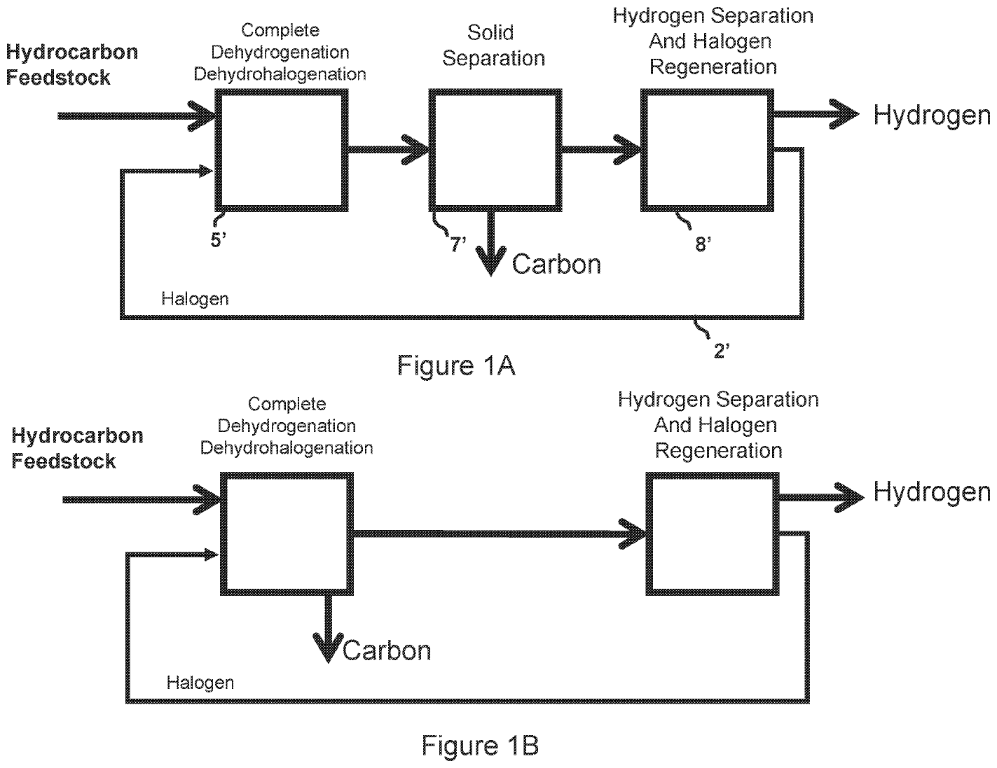

FIGS. 1A and 1B schematically illustrate how a hydrocarbon feedstock can be reacted with a halogen to produce solid carbon, hydrogen halides, and hydrogen. In FIG. 1A, a hydrocarbon feedstock can be introduced into a dehydrogenation and dehydrohalogenation reactor 5′. As described below, the hydrocarbon feedstock can include any type of hydrocarbons. The product of the reaction can include carbon that is shown to be continuously removed from the reactor with the hydrogen and hydrogen halide. The products can then pass to a separator 7′ to remove the solid carbon. The remaining gas phase products can then pass to a hydrogen separation and halogen regeneration, where the hydrogen can be separated and produced as a product while the halogen is recycled back to the reactor 5′. In this unit 8′, the hydrogen halide can be converted to hydrogen and the halogen recovered in an energy consuming process such as an electrolyzer. The recovery of halogen is described in more detail herein. In FIG. 1B, the system and process are similar, except that the carbon can be removed separately (as in conventional petroleum cokers) while the gas phase products can pass to the hydrogen separation and halogen regeneration process and system.

Alternatively, reaction of the hydrogen halide generated during the dehydrogenation/dehydrohalogenation with oxygen can be used to regenerate the halogen and generate potentially useful heat. In principle, no energy is required at all, however, there is a loss of a fraction of the hydrogen product. The reaction can proceed according to the following equation:

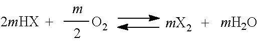

The overall process reaction for the electrochemical halogen regeneration is identical to pyrolysis (CH₄+energy→2H₂+C), while the overall reaction when the hydrogen halide is reacted with oxygen is analogous to the ideal oxygen mediated pyrolysis (CH₄+x/2O₂→(2-x)H₂+H₂O+C).

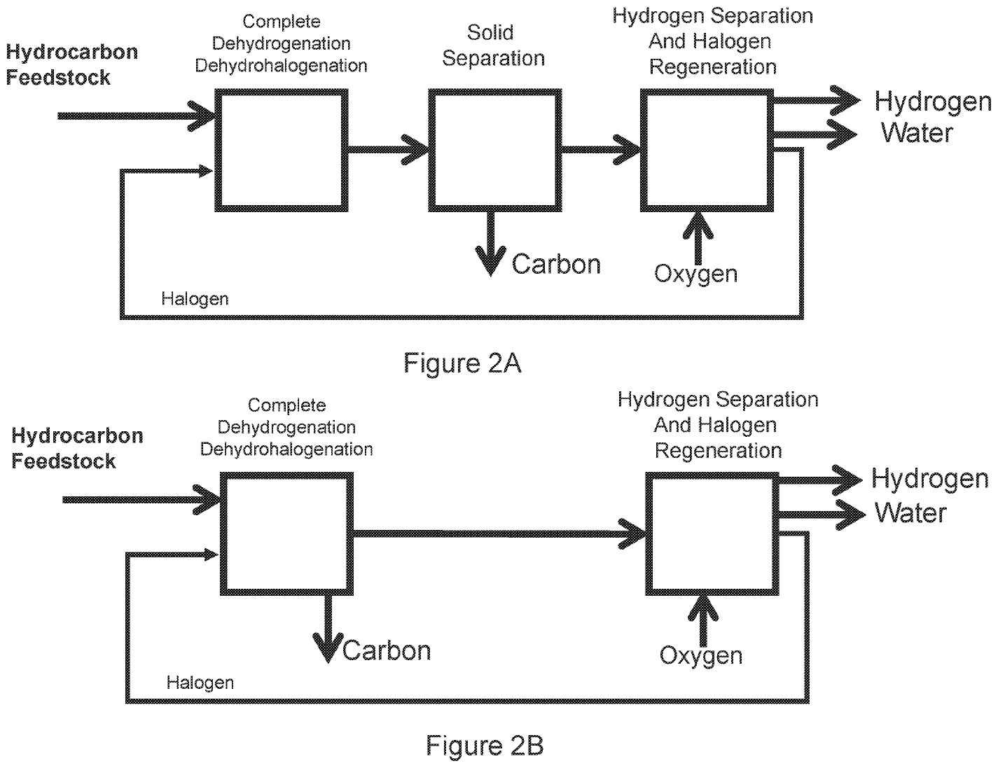

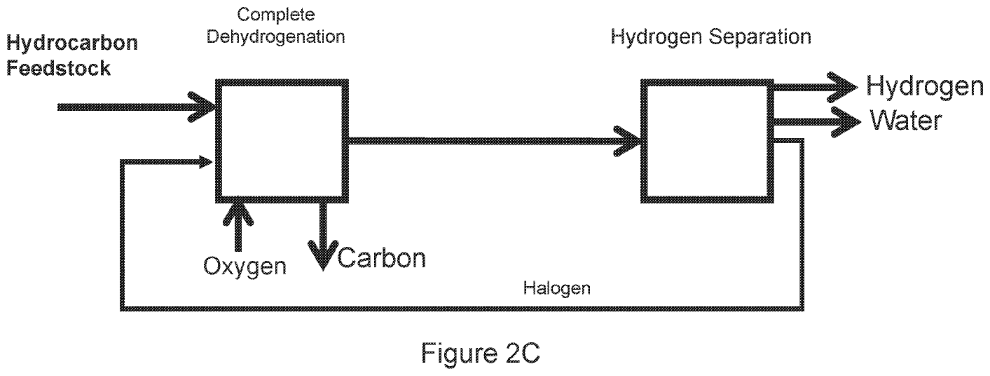

FIGS. 2A and 2B schematically illustrate how any hydrocarbon feedstock can be reacted with a halogen in an oxygen mediated process to produce solid carbon, hydrogen halides, and hydrogen. In FIG. 2A, carbon is shown to be continuously removed from the dehydrogenation/dehydrohalogenation reactor with the hydrogen and hydrogen halide before passing to a solids separation step. The solid carbon can be separated and the remaining gas phase reactants can pass to the hydrogen separation and halogen regeneration reactor and process. The hydrogen halide can be reacted with oxygen in the hydrogen separation and halogen regeneration reactor and process and converted to water and the halogen recovered in an energy producing process. The recovery of halogen is described in more detail herein. In FIG. 2B, the carbon can be removed separately (as in conventional petroleum cokers) while the gas phase products can pass to the hydrogen separation and halogen regeneration process and system using oxygen to produce water and hydrogen while regenerating the halogen.

The process as shown FIG. 2C can also carry out the reaction of a hydrocarbon feedstock with a halogen in an oxygen mediated process to produce solid carbon, hydrogen halides, and hydrogen, where the dehydrogenation reaction occurs in the presence of the hydrocarbon, the halogen, and oxygen. The overall reaction can proceed as follows:

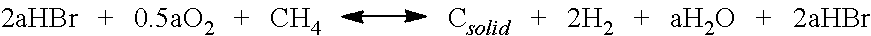

In this process, the reaction of the feed stream can produce an autothermal reaction to generate high temperatures to carry out the halogen mediate pyrolysis of the hydrocarbons, and the presence of the halogen can prevent carbon oxidation to a carbon oxide. While not wishing to be limited by theory, the halogen can then serve as a source for the autothermal reaction while serving as a catalyst for the pyrolysis reaction.

As shown in FIG. 2C, the reactor can receive a hydrocarbon feedstock with a halogen along with a feed of oxygen. The resulting products can include solid carbon, and a stream comprising hydrogen, steam, and a hydrogen halide, which can then pass to and be separated in a downstream separator. The hydrogen halide can be regenerated using any of the processes described herein with the halogen and/or hydrogen halide being recycled to the dehydrogenation reactor.

Although methane was discussed above the same processes and methods are applicable for any hydrocarbon decomposition. The systems and methods disclosed herein leverage the internal energy of the reduced carbons in fossil hydrocarbons and reduce or eliminate the energy required for producing hydrogen.

This systems and methods disclosed herein provide a means of producing hydrogen from hydrocarbons with the same low overall energy input advantage of conventional pyrolysis, or the idealized partial oxidation with the valuable additional benefit of eliminating the need to add heat to a high temperature reactor, thus solving a major problem facing proposed industrial pyrolysis processes. Fundamentally, this provides a shift of the energy input step from the hydrocarbon reaction to the halogen recovery step which is a significant advantage over prior processes.

By making use of partial oxidation with a non-oxygen containing oxidant that cannot make carbon dioxide, the dehydrogenation of hydrocarbons can be accomplished in two fundamental consecutive steps illustrated schematically in FIGS. 1A-1B and FIGS. 2A-2B. The hydrocarbon can be contacted with a halogen, X, at a sufficiently high temperature to produce the equilibrium products including solid carbon, molecular hydrogen, and hydrogen halide, HX. In some aspects, the contacting can be carried out under halogen limited conditions. The following equation can represent the reaction.

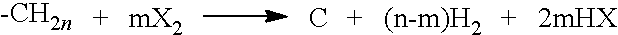

The reaction products can be separated and the hydrogen halide reacted to recover the halogen.

As illustrated in FIGS. 1A and 1B, the gas phase products including a hydrogen halide can pass to the hydrogen separation and a halogen regeneration process and system to regenerate the halogen. The reaction of the hydrogen halide can produce additional hydrogen by conversion of the hydrogen halide to hydrogen and the halogen through a number of pathways—all requiring a net addition of energy either as heat or electricity or another reactant as inputs recovering the halogen for reuse. The conversion of the hydrogen halide to hydrogen and the elemental halogen is represented by the following equation:

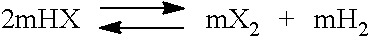

No matter how the regeneration is performed, energy is required. The enthalpy and free energy changes are different for the different halogens with fluorine requiring the greatest energy input to recover F₂ and hydrogen and iodine approximately no energy at all. Whereas, use of a very small amount of F₂ or fluorinated halogenation agent in the dehydrogenation reactor could produce more H₂, the practical aspects of recovering all of the F from the carbon and regeneration of the halogen may be challenging, and thus fluorine is less desirable. Similarly, iodine is less effective for complete dehydrogenation under many practical conditions and greater amounts are required even though the recovery is easier. In general, the process may be carried out using chlorine or bromine. The relative energies of the process steps are shown in Table 1.

TABLE 1

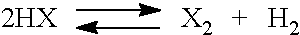

| | DHo | DGo |
|---|---|---|
| | kJ/mole | kJ/mole |
| X2 | H2 | H2 |
| F2 | 545 | 549 |
| Cl2 | 185 | 191 |
| Br2 | 73 | 108 |
| I2 | −53 | 0 |

This regeneration process can also be carried out thermochemically in a chemical looping process represented schematically as,

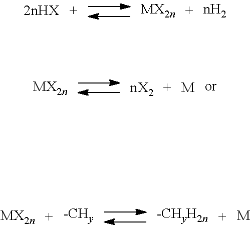

For example, by reacting the hydrogen halide, e.g., 2HBr, with an appropriate metal (e.g. Zn) to form a metal halide (ZnBr₂) and hydrogen. The ZnBr₂ can then itself be used as a halogenating agent or decomposed to Zn and the halogen.

Other embodiments can make use of a combination of electrochemical and thermochemical processes to allow efficient energy storage to be coupled to the process. For example, in some embodiments, the hydrogen halide can be contacted with a high temperature alkali metal (e.g., Na, K, Li) or alkaline earth (e.g., Mg, Ca) to produce the halide salt and hydrogen gas in a heat generating reaction maintaining the salt in a molten state,

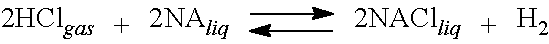

The molten salt can be coupled to an intermittent electricity grid making use of low-cost electricity to electrochemically regenerate the halogen from the molten halide salt as needed.

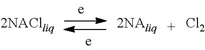

Alternatively, as illustrated in FIGS. 2A and 2B, the hydrogen halide can be reacted with oxygen to recover the halogen and produce heat which may be useful elsewhere in the process at the expense of not producing as great a hydrogen yield. The relative energies associated with this regeneration route are shown in Table 2.

TABLE 2

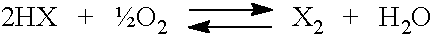

| | DHo | DGo |
|---|---|---|
| | kJ/mole | kJ/mole |
| X2 | X2 | X2 |
| F2 | 259 | 313 |
| Cl2 | −101 | −457 |
| Br2 | −213 | −129 |
| I2 | −338 | −239 |

This regeneration process can also be executed thermochemically in a chemical looping process represented schematically as,

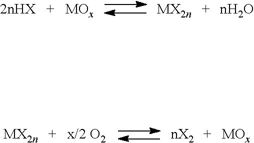

The generation of water can then require the separation of the halogen from the water prior to recycling the halogen to the process. The separation can use various separation processes to perform the water removal.

In some aspects, the reaction of the hydrocarbon feedstock (e.g., methane) can be carried out in a reactor with bromine or chlorine in molar ratios, methane:halogen, of between 10:1 and 1:2. The reaction temperature can be between about 650° C. to about 1700° C. (or alternatively between about 700° C. and about 1500° C.) and a pressure between 1 bar and 100 bar to produce products including hydrogen, hydrogen bromide or chloride, and a carbon containing solid.

An advantage of the present systems and methods is that they enable, over other process options for hydrocarbon processing, the production of two intermediates that can be stored at low cost under mild conditions, namely the hydrogen halide and the halogen. This provides an important aspect of the present systems and methods, namely, intrinsic energy storage potential.

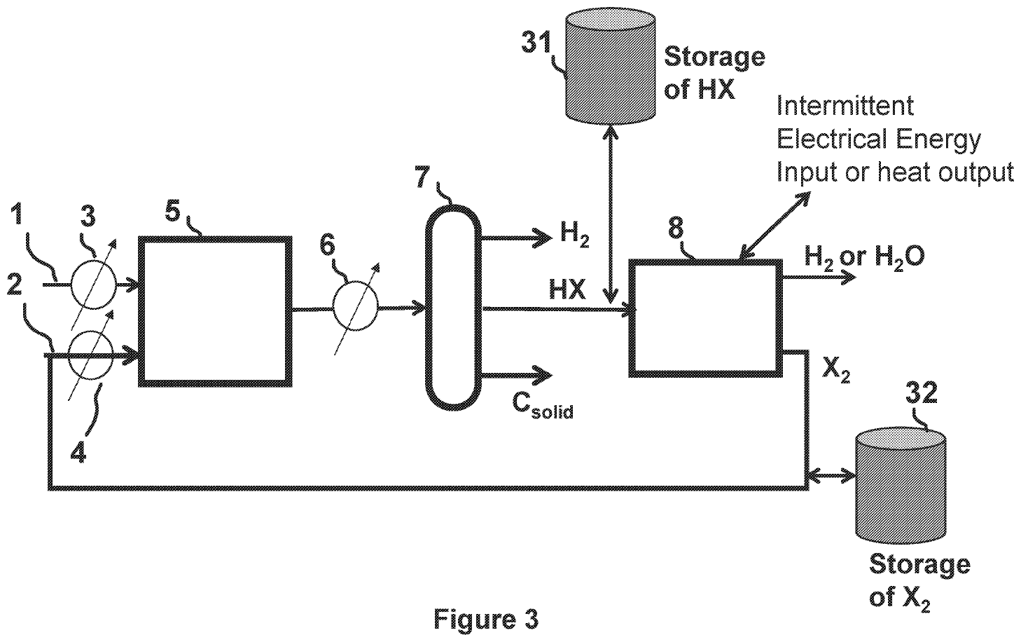

As shown in FIG. 3, storage vessels 31, 32 are shown where the hydrogen halide and halogen, respectively, can be stored. As shown, the continuous hydrocarbon feed in stream 1 can be contacted with a continuous halogen recycle in stream 2 in a reactor 5 operated at the temperatures described herein (e.g., between about 650-1700° C. or between about 700-1200° C., etc.). A heat exchanger 3 may be used to pre-heat the hydrocarbon feed stream 3 and a second heat exchanger 4 may be used to pre-heat the halogen stream 2. The use of separate feed streams and pre-heaters such as heat exchangers 3 and 4 is described in more detail herein. The products from the reactor can be passed through a heat exchanger 6 before passing to a separator 7. The hydrogen halide can be provided to the regeneration unit 8 and/or halogen storage unit 32. Hydrogen halide may be stored (for example as an aqueous electrolyte) in a storage tank 31 such that when intermittent electricity is available, the electricity can be used in the halogen regeneration unit 8 to produce the halogen and hydrogen or water, where the halogen can be used to replenish the halogen storage tank 32. The halogen can then be passed back to the reactor for further reaction. As shown, this allows for the storage and regeneration of the halogen as hydrogen halide and/or elemental halogen.

This allows the use of intermittent energy sources such as provided by wind or solar resources that can provide the carbon dioxide free heat or electricity for regeneration, or generate heat in the oxidation reactor when heat is required (for example to use in a steam cycle backing a renewable source). In some embodiments, intermittent renewable electricity can be used for electrochemical cells used to regenerate the halogen from stored hydrogen halide removed from the hydrogen stream. For example, the hydrogen halide can be scrubbed from the hydrogen stream in a wash column that concentrates the acid in a liquid form that can be stored at low cost. If intermittent electricity is available at low cost, the process can adapt to the intermittency by storing the hydrogen halide reactant as well as the halogen product in low-cost storage vessels for proper timing to match the electricity supply.

It is typical in chemical production for facilities to produce many products. The present systems and methods provide new opportunities for emissions-free production of chemical products such as olefins, aromatics, oxygenates, and hydrogen in the same chemical complex. Many of these important chemicals can be produced using halogen through an alkyl mono-halide intermediate (including propylbromide, ethylbromide, butylbromide, methylbromide, methylchloride). A major advantage of these processes is the ease of separation of the monohalides from polyhalides and reactant alkanes. Such processes have had limited deployment due to the complexities and costs of managing polyhalogenated intermediates.

In some embodiments, chemical complexes can be effectively generated using a hydrocarbon feed consisting of a mixture of hydrocarbons such as natural gas with methane, ethane, propane, and other components, partially refined crude oil, or crude oil. Such mixed feeds can be processed readily with halogens to produce mixtures of polyhalogenated species that are readily separated into monohalogenated intermediates and mixtures of polyhalogenated species. The separated monohalogenated intermediates can be processed to valuable chemical products while the other components can be mixed with specific compositions of hydrocarbon reactants to allow for autothermal pyrolysis of the mixture to produce hydrogen, hydrogen halide, and solid carbon. This process can allow for the production of value-added chemicals while avoiding the need to handle polyhalides.

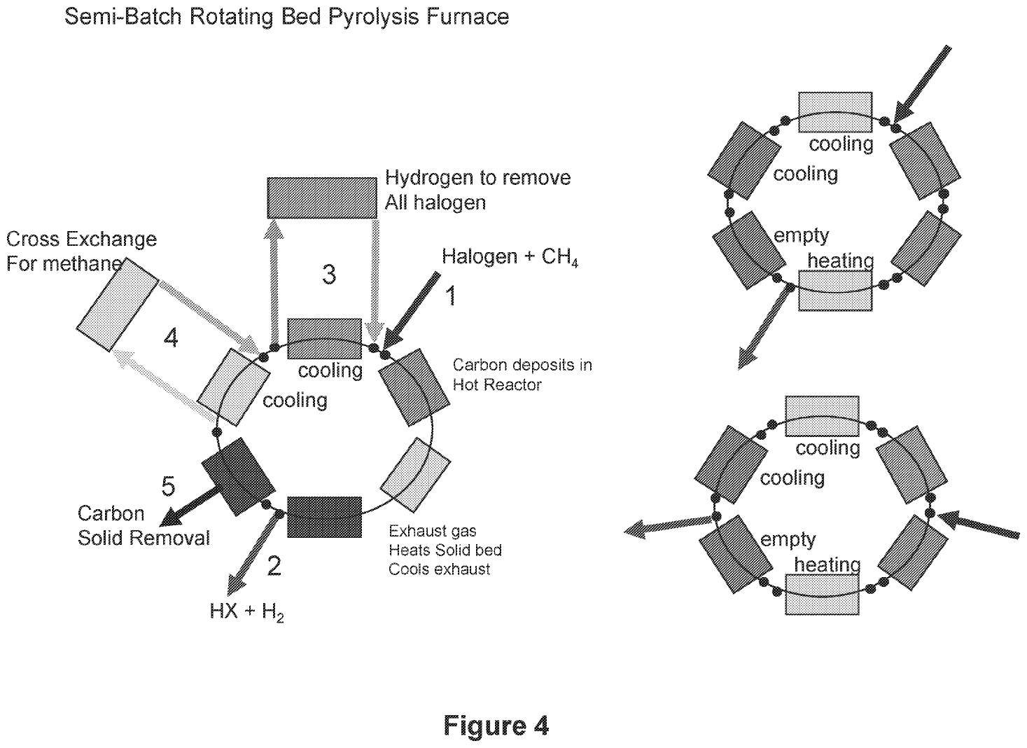

In some embodiments as shown in FIG. 4, heat integration can also be achieved in a semi-batch rotating packed bed reactor configuration. The resulting configuration can simulate a moving bed with one or more generally stationary beds by control of the flow of reactants and products within the system. To start, the hydrocarbons and halogens can be introduced at position 1 (FIG. 4 left). The hydrocarbons and halogens can flow through a heated packed bed vessel (the vessel in the clockwise direction in FIG. 4) containing a porous solid material (e.g., carbon), and the reaction can proceed to leave the solid product on the reactor packing, thereby adding mass to the vessel in proportion to the hydrocarbon converted. By virtue of the relatively high reactor temperature, hydrodehalogenation occurs freeing the solid carbon of halogen residue. In some aspects, the reaction can occur at a temperature between about 650-1700° C., or between about 700-1200° C.

Using a valve network, the reactor product gases can leave the reaction vessel and move clockwise in FIG. 4 to enter a second vessel containing the packing material. The hot product gases comprising primarily hydrogen and hydrogen halide can exchange heat with the reactor internals to pre-heat the reactor internals as the product gas is cooled. The gases may then be passed through another identical vessel (e.g., continuing clockwise in FIG. 4) before exiting at outlet 2 as a gas stream comprising primarily hydrogen and hydrogen halide.

Using a system of valves between the reactor beds the reaction vessel formed by the use of a plurality of vessels (e.g., the vessels between the inlet point 1 and the outlet 2) can be moved in a clockwise manner around the network of reactors. The remaining reactor beds can be isolated for treatment prior to being reintroduced into the reaction vessel loop. For example, after serving as a reactor the bed, a bed can be switched to an isolated loop 3, where an inert gas and/or hydrogen can be circulated through the previous reaction bed to remove all traces of halogens and begin the cooling process. A previously degassed bed 4 can be further cooled by circulating an inert gas potentially cross-exchanging the heat with the hydrocarbon feed gas. Once cooled the vessel 5 containing the solid carbon can be emptied or partially emptied to remove the net carbon deposited and leaving sufficient packing to repeat the cycle. Various carbon removal processes can be used the carbon from the vessel. Once the carbon is removed, the process can continue to move the reactant entry and exit points in a clockwise direction in a semi-batch process to continue the reaction process.

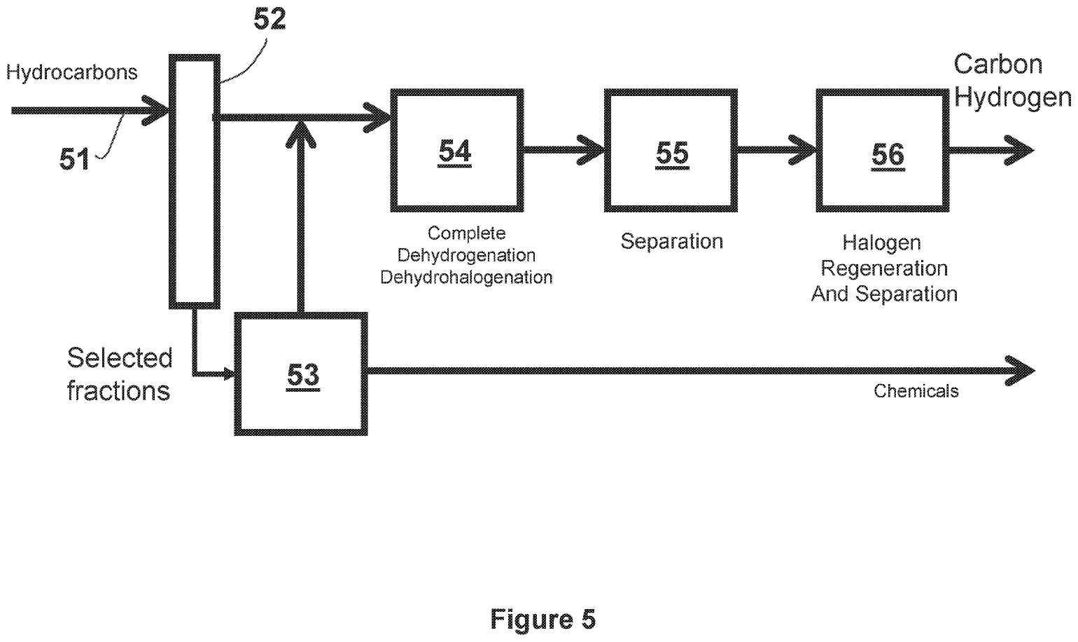

FIG. 5 shows schematically a plant level integration for a hydrocarbon feed stream 51 such as natural gas containing methane, ethane, and propane that can be separated and reacted with a halide such as bromine to produce monobromides of methane, ethane, and propane as well as polybrominated intermediates and unreacted alkanes in a reactor 52. The monobromides can be separated and used to produce more valuable chemical products in a reactor 53. FIG. 5 illustrates the production of chemicals such as aromatics from methylbromide, and ethylene and propylene from the ethyl and propyl bromides. All the polybromides and unreacted alkanes can then be reacted together with additional methane in a reactor to produce solid carbon and hydrogen that can be separated in separator followed by regeneration of the bromine in regenerator and separator. Such a process and system might also integrate energy storage features in the halogen and hydrogen halide storage facilities as described herein to make use of renewable intermittent electricity. Electrolysis can be used to regenerate the bromine, however, other recovery methods may also be used such as oxidation with air.

In some embodiments, the system of FIG. 5 can be used with a mixed hydrocarbon feed 51 (e.g. crude oil, wet natural gas, etc.) with selected fractions removed for further processing. Processing can make use of traditional processes with difficult to use hydrocarbon fractions or intermediates returned to the pyrolysis stream. As shown in FIG. 5, the hydrocarbons can be separated in a separator 55 to produce one or more fractions. Some fractions can be sent to process for the production of value-added chemicals and/or leave the system as the selected fractions. The remaining hydrocarbons can be passed back to the halogen mediated pyrolysis process for complete dehydrogenation and dehydrohalogenation in reactor 54 followed by separation in separator 55 and halogen regeneration and recovery in process 56. The remaining hydrocarbons can then be converted to hydrogen and carbon within the process. This process can allow for the selected fractions to be separated for use while the remaining less desired fractions may be used to produce hydrogen and carbon as described herein.

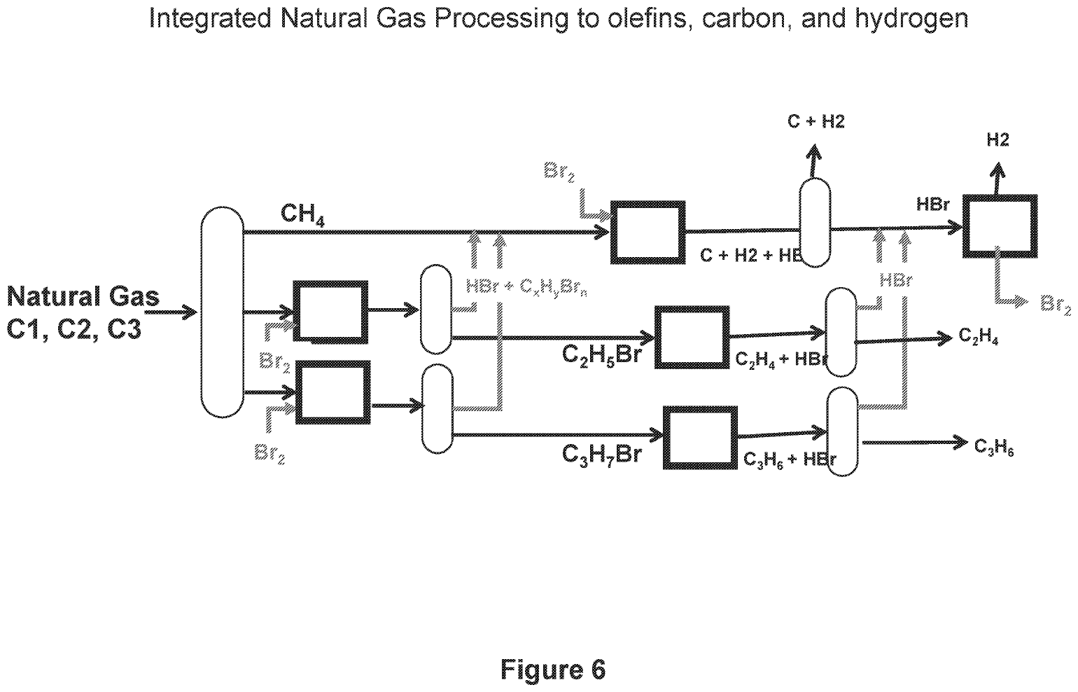

An exemplary embodiment of the process described with respect to FIG. 5 is shown schematically in FIG. 6. As illustrated, natural gas containing a mixture of alkanes can be fractionated in a fractionation column, and the ethane and propane can be reacted with halogen (for example bromine) in a low temperature halogen limited halogenation reactor to produce a number of different single and multiple halogenated products and hydrogen halide. The products of the halogenation steps can be separated, and selected halogenated products can be used to produce valuable final products (e.g., ethylbromide and proplybromide which can easily be reacted to produce ethylene and proplyene). Any remaining hydrogen halide and other products can be passed to the halogen mediated pyrolysis process train. For example, other mixed products can be separated and mixed together and sufficient halogen added to convert all of the hydrocarbons and halogenated hydrocarbons to carbon, hydrogen, and hydrogen halide using any of the system and methods described herein. This aspect of the present systems and methods enables integrated hydrocarbon (natural gas and oil) refining with large scale energy storage all at the same facility.

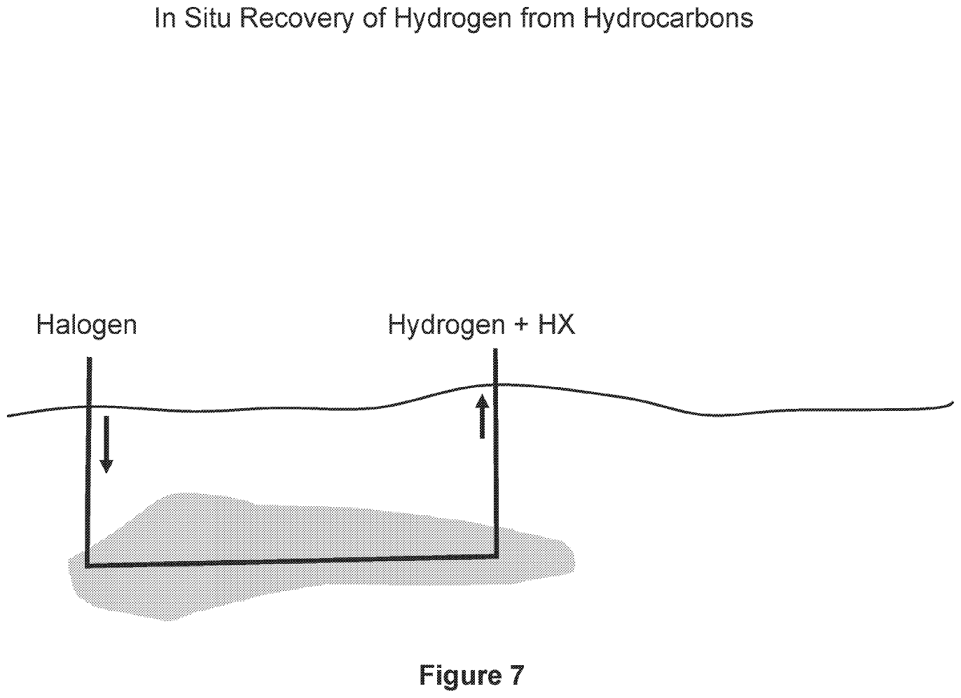

In other aspects as shown in FIG. 7, hydrocarbon resources can be autothermally reformed in situ (including while still underground) by feeding a halogen or halogenated oxidant into the formation with or without some initial heating and controlling the halogenation to provide sufficient exotherm to maintain the conversion temperature. This process can result in leaving the solid carbon product in the formation and recovering the gaseous hydrogen halide and hydrogen. Use of modern methods of hydraulic fracturing may be used to increase the access of the halogen to the hydrocarbon resources and provide for a subsurface flow pattern allowing for efficient removal of the volatile hydrogen halides. For example, a system of injection and production swell as shown in FIG. 7 can be used to produce a flow pattern with the halogen injected into the injection wells and the hydrogen and hydrogen halide produced from production wells. Monitoring (e.g. of temperature) and in situ heating can be provided through additional boreholes. In some embodiments, the temperature of the reaction zone can be maintained at a temperature suitable for removing the halogens from the carbon during the reaction. For example, the solid carbon heated high enough in temperature to recover all the halogen remains in the formation.

In some embodiments, a step that can simplify the previous engineering challenges of pyrolysis is in the reaction with the hydrocarbon as an exothermic reaction step. This may reduce or eliminate the need for energy input such that little to no heat needs to be added to the high temperature reactor and low-cost adiabatic designs may be used during operation (though some amount of heat may be used for startup). This important simplification can allow significant cost reduction, process simplification, and reactor options such as semi-batch or moving beds.

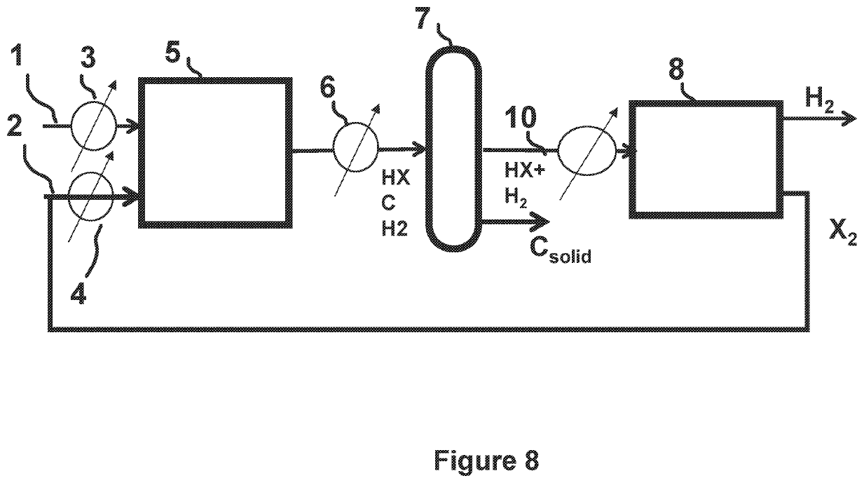

In some embodiments, a hydrocarbon feed stream comprising methane (e.g., from natural gas) can be used as a feedstock stream 1 that is contacted in a reactor 5 with a halogen 2 in the first process step as shown in FIGS. 8-10, which can be similar to the system as shown in FIG. 3. A heat exchange 3 can be used to adjust the temperature of the feed stream 1 prior to entering the reactor 5. Additional details of the systems and corresponding processes for FIGS. 8-10 are described below. In the reactor 5, products can be generated according to the following equation.

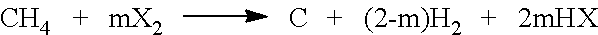

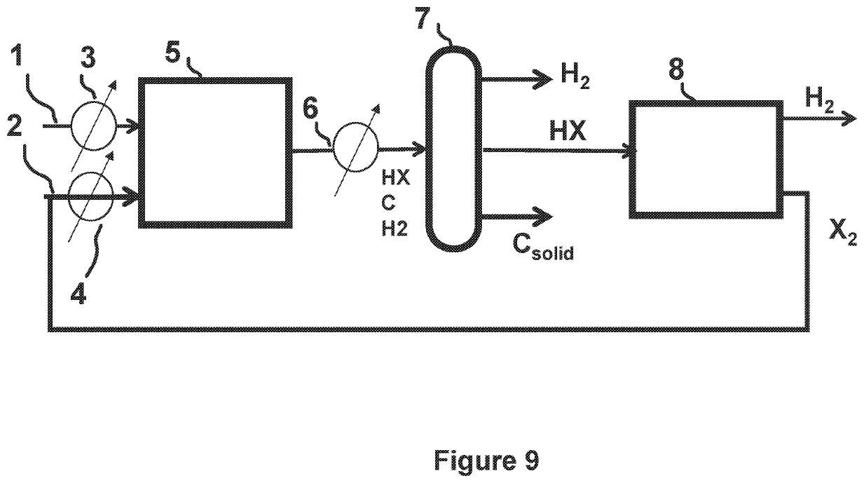

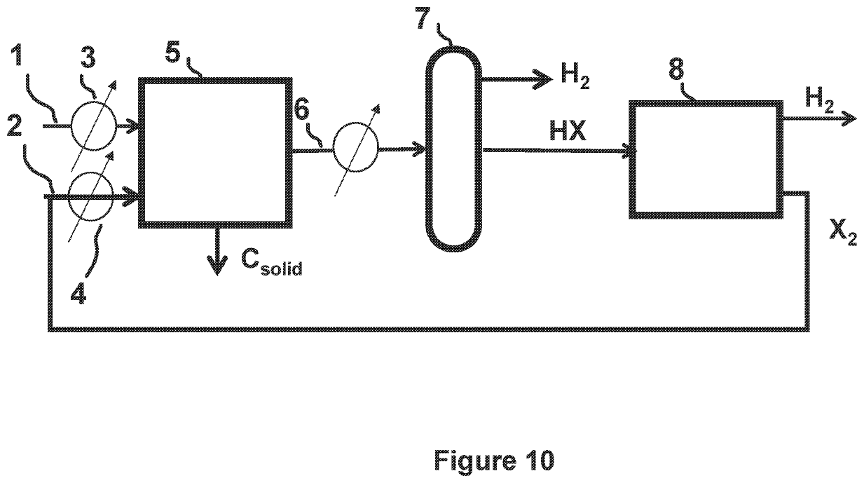

The products can comprise carbon containing solids, hydrogen, and hydrogen halides. The product stream can pass through a heat exchanger 6 to cool the product stream prior to passing the product stream to the separator 7. The hydrogen can be separated before (e.g., as shown in FIGS. 9 and 10), or after (e.g., as shown in FIG. 8), the halogen regeneration unit 8. The solid carbon product can be removed from the reactor 5 with the gaseous hydrogen and hydrogen halide (e.g., as shown in FIGS. 9 and 10), or from the dehydrogenation reactor itself (e.g., as shown in FIG. 10). The halogen regeneration unit 8 can generate a halogen stream that can be recycled to the reactor 5. A heat exchanger 4 can be used to adjust the temperature of the halogen (e.g., heating the halogen) prior to the halogen being introduced into the reactor 5.

The type and amount of halogen added to the reactor 5 can be varied to control the hydrogen produced and reaction energies. If one halogen is combined with one methane molecule the standard state enthalpies and free energies are given below:

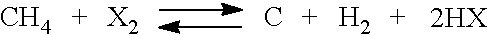

| | DHo | DGo |
|---|---|---|
| | kJ/mole | kJ/mole |
| X2 | CH4 | CH4 |
| F2 | −430 | −499 |
| Cl2 | −110 | −140 |
| Br2 | 2 | −57 |
| I2 | 138 | 53 |

Whereas reaction with iodine would require heat addition to the reactor, all other halogens would generate some heat with the fluorine reaction particularly exothermic.

In some embodiments, the amount of energy required to be added to a reactor at 1 bar and 900° C. can be almost zero with bromine or chlorine as follows.

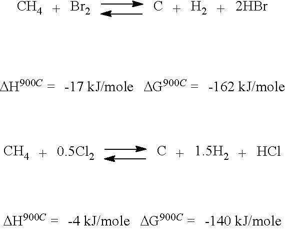

Note that more molecular hydrogen can be produced using chlorine, however, the energy required to recover the chlorine is greater per molecule than with bromine such that the energy inputs are approximately the same overall, however, smaller reactors/electrolyzers are required for the lower production rate. The capital cost of the electrolyzer is lower with chlorine but the energy use is greater because of a higher voltage requirement. Both processes are slightly exothermic and expected to proceed to completion at the reaction temperature described herein, thereby eliminating the equilibrium limits of traditional pyrolysis. Bromine and chlorine as well as other halogens have a potential role in halogen mediated pyrolysis. For both bromine and chlorine, a number of common electrochemical cells may be used for regenerating the halogen and hydrogen including but not limited to aqueous cells, gas phase electrolysis cells, molten salt electrolysis, or others know to the those skilled in the art with the benefit of this disclosure.

In some embodiments, the reaction transforming hydrocarbons to solid carbon, hydrogen, and water without the need to add any energy at all is described whereby the hydrocarbon (here with methane as an example) is reacted with a limiting amount of halogen to produce solid carbon, hydrogen and hydrogen halide. The reaction is conducted with sufficient halogen to require insignificant or no heat addition,

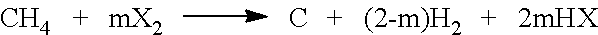

The halogen is recovered by reaction with oxygen,

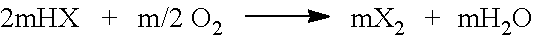

The overall reaction is,

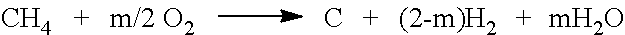

In some aspects, chlorine can be used as follows,

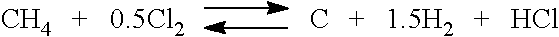

At the reaction temperatures described herein, the exothermic reaction proceeds to completion even at high pressures with no energy input. The chlorine can be regenerated by reacting the HCl with oxygen as follows,

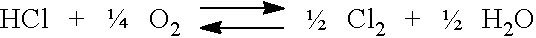 [SMILES: Cl ; "O2" ; "Cl2" ; O]

The chlorine and water can then be separated with the chlorine being recycled within the system. In some aspects, the halogen used in the system can be chlorine. Chlorine handling is known to the industry and may be more environmentally acceptable in some instances than other halogens.

Some embodiments are shown in FIGS. 8-10 whereby a hydrocarbon feed stream 1 can be heated in an exchanger 3 and introduced into a reactor 5 along with a fraction of halogen 2. The halogen can include any of those described herein. The reactor can be maintained at a temperature sufficient for complete consumption of the halogen and conversion of the hydrocarbon to solid carbon. In some aspects, the reaction may proceed at a temperature between about 700-1200° C. In FIG. 8, the products comprising primarily hydrogen, hydrogen halide, and solid carbon can exit the reactor 5 and pass to a separate 7 to undergo a gas-solid separation to remove the solid carbon (e.g. in a cyclone or filter system). An exchanger 6 can be used to adjust the temperature of the product stream prior to passing to the separator 7. The hydrogen halide can then be reacted in a halogen recovery unit 8 and decomposed to hydrogen and the elemental halogen. This can be done using electrolysis (e.g. 2HBr→H₂+Br₂), and/or by thermochemical processes (2HX+M→MXₙ+H₂, MXₙ→M+X₂) as described in more detail herein. It is also possible to use an oxidative process to react the hydrogen halide with oxygen producing heat and halogen if the heat is useful in the process elsewhere.

In another embodiment as shown in FIG. 9, the main elements of the system are similar, and the description with respect to FIG. 8 applies to the same or similar elements. In FIG. 9, the products comprising primarily hydrogen, hydrogen halide, and solid carbon can exit the reactor 5 and undergo separation to remove the solid carbon (e.g. in a cyclone or filter system) and hydrogen (e.g. by pressure swing absorption). The hydrogen halide can then be reacted in a halogen recovery unit 8 and decomposed to hydrogen and the elemental halogen as described above.

In another embodiment as shown in FIG. 10, the main elements of the system are similar, and the description with respect to FIGS. 8 and 9 applies to the same or similar elements. In FIG. 10, the solid carbon produced from the reactants remains within the reactor or are removed continuously by a separated stream. The process may be operated in a continuous or semi-batch manner such that when the carbon product has sufficiently built up the process is switched to another vessel and the solid co-product can be removed. The gas phase products can exit the reactor 5 and can undergo separation to remove the hydrogen from the hydrogen halide (e.g. by pressure swing absorption). The hydrogen halide can then be reacted in a halogen recovery unit 8 and decomposed to hydrogen and the elemental halogen as described above.

An important aspect of the present systems and methods is the production of a clean, substantially contaminant-free, carbon product that can be sold or stored such that it never goes into the atmosphere as CO₂. This means the carbon product must be free of significant halogen contamination. Because of the design of the high temperature hydrogen containing reaction environments, the halogens that do form bonds with carbon can desorb or react with the hydrogen also present by design. Iodine, bromine, and chlorine are preferred halogens because their bond energies with carbon are weak enough such that at the preferred reaction temperatures of greater than 700° C., the bonds can be broken (especially in the presence of background hydrogen) and all halogen removed from the solid carbon product by hydrodehalogenation.

In another embodiment of the invention carbon produced in the primary reaction is reacted in a second step with a non-halogenated reactant including but not limited to gases (including but not limited to hydrogen and light alkanes) and/or liquids (including but not limited to alkaline hydroxide bases (NaOH)).

The various systems and methods described herein can use various reactor designs to contact the hydrocarbons with halogens. Any suitable reactor design can be used to cause the hydrocarbon and halogen to react, which can occur at a temperature in a range of about 650-1700° C., or between about 700-1200° C.

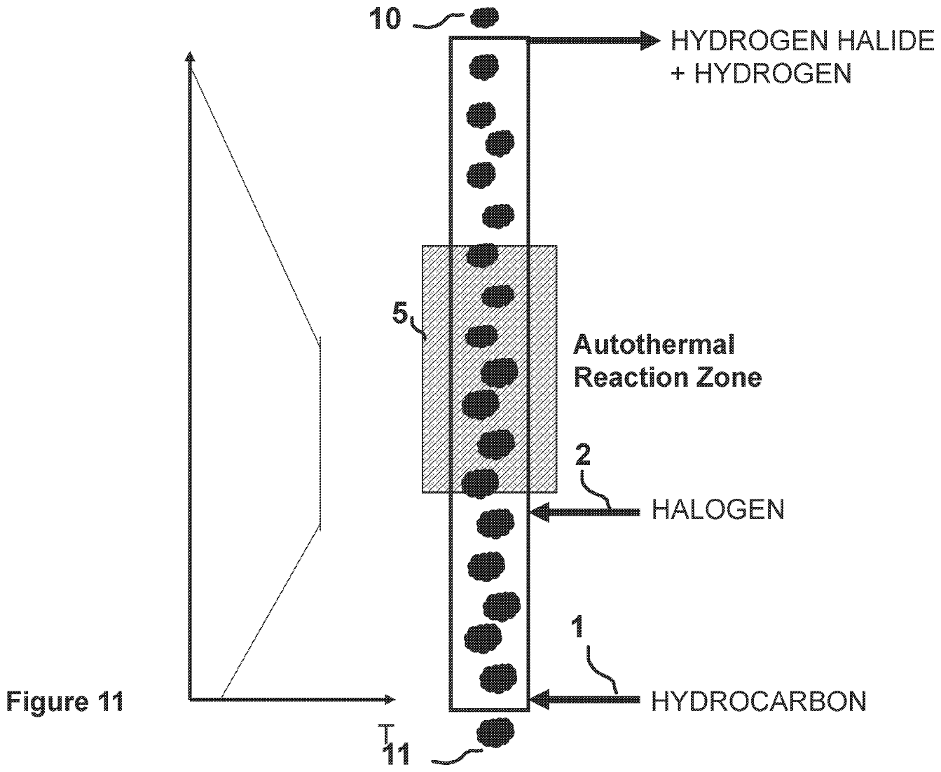

FIG. 11 illustrates a schematic reactor configuration. Heat integration can be used with the reactor by employing a moving bed of solid carbon or other solid that can move under gravity from the top feed zone 10 counter-currently to the upward flowing gas stream, and exit at the bottom 11. As shown, low temperature feed gas can be introduced in a feed stream 1 in a lower portion of the reactor near the solid outlet, rise countercurrent to the down going solid to exchange heat to cool the solid and heat the feed stream. A stream comprising a halogen, which can be preheated, can be introduced in feed stream 2 below the reaction zone of the reactor. The halogen stream 2 can mix with the heated feed gas stream 1 and react within the central region of the reactor to deposit solid carbon on the downward moving solids and build up the solid carbon's mass. The halogenation reaction is exothermic, and the exotherm of the reaction and any added heat can cause the maximum reactor temperature to occur in a central region of the reactor after the halogen is added. As the gas continues upward out of the central region, the gas (e.g., a mixture of products and unreacted reactants) can exchange heat with the downward moving solid bed, which can be introduced at the top at lower temperature than the temperature of the reaction zone. The gas phase products can leave the reactor lower in temperature than the temperature at which the gas exits the reaction zone and the downward moving solids can increase their temperature prior to entering the central reaction zone. The reactor temperature profile is shown to the left of FIG. 11.

In some embodiments, the hydrocarbon 1 can be introduced into the reactor separately from the halogen 2 to prevent their reaction prior to entrance in the reactor. Both the hydrocarbon and the halogen can be preheated. In some aspects, the halogen can be heated to a higher temperature than the reaction temperature and the hydrocarbon to a lower temperature than the reaction temperature.

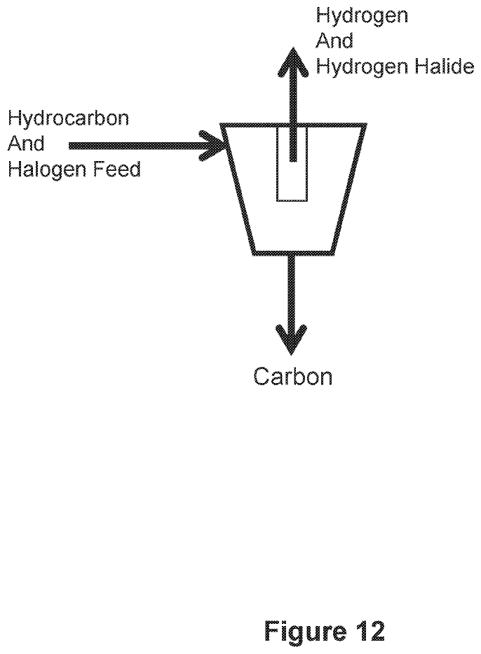

FIG. 12 schematically illustrates a reactive separation in a cyclonic flow reactor. As shown, the cyclonic flow reactor can be configured to separate the solid carbon formed in the reaction from the gas phase reactants and products. This can allow the solid phase product (e.g., the carbon) to be removed from the reactor separately from the gas phase products and any remaining reactants. As shown in FIG. 12, the reactor can take the form of a cyclone. The gaseous feed streams can be introduced tangential to an inner wall to generate the cyclonic flow within the reactor.

In use, the hydrocarbon and halogen can be reacted in the cyclone to allow the reaction to produce solid carbon, which can be segregated in the cyclonic flow field allowing the solid carbon to be removed separately from the gas phase co-products. For example, the cyclonic flow can separate the solids to a lower portion of the reactor for removal while the gas phase reactants and products can leave a top portion of the reactor. In a continuous implementation, the carbon can be removed as it is produced. In some aspects, the reactor may operate in a semi-batch implantation where carbon can be deposited within the cyclonic flow vessel around the wall of the reactor, building up in time in a pattern consistent with the flow-field which will reduce the diameter over time. The vessel can be periodically taken off-line and the carbon removed.

In the various systems and methods disclosed herein, the halogens are heated for use in the reactions. The challenge of materials of construction for halogen processes is addressed. Halogens, in particular fluorine, chlorine, bromine, and iodine, are difficult to heat to high temperatures because heat exchange materials are limited. There are however many insulating ceramics stable in the presence of high temperature halogens. The exothermic reaction of the hydrocarbon and the halogen can be used to provide the heat required to raise the reactant temperature inside of an insulating ceramic lined vessel such that the heat required comes from combining the halogen and the hydrocarbon. In one example, the hydrocarbon is heated to just below reaction temperatures in a conventional heat exchanger (e.g. methane heated to 500° C.). Dry halogen can be heated to the maximum temperature possible in conventional materials (e.g. Cl₂ heated in ceramic lined exchanger to 300° C.). The reactants can then be introduced into a ceramic lined reactor where they combine in the exothermic reaction to produce solid carbon, hydrogen, and hydrogen halide. The heat generation requires that less hydrogen is generated and more hydrogen halide, however, the practical benefits in widening the materials of construction choices and costs can outweigh the costs. In some aspects, the isothermal approximately autothermal reaction at 1200° C. of CH₄+0.5Cl₂→C+1.5H₂+1HCl must be modified with additional chlorine addition,

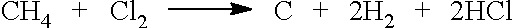

to provide the reaction heat needed to heat cooler reactants introduced at approximately 300° C. within the reactor to 1200° C.

Heating of halogens to high temperatures can be challenging, in another preferred embodiment of the invention, direct contact of halogen gases with a molten salt is utilized in a bubble column heat exchanger. In one specific example a bubble lift configuration is utilized to circulate molten CaCl₂) salt (with a low vapor pressure) around a loop containing a heating element or heated by induction. Chlorine gas can be introduced at the bottom of the bubble column and heated to reaction temperature before leaving the direct contact heat exchanger and moving into the reactor.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

Continuous Generation of Hydrogen and Hydrogen Halide from Methane

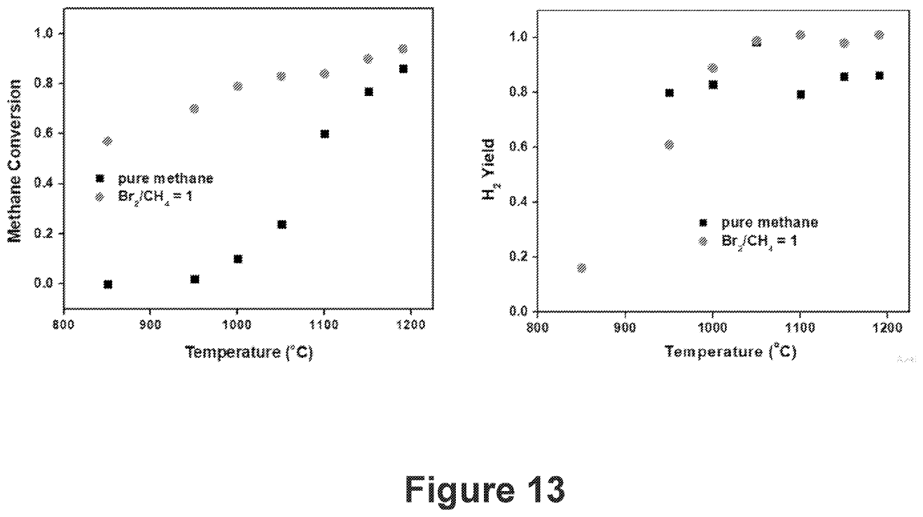

In a specific example, 6 sccm of methane is contacted with 54 sccm of varying molar ratios of bromine and argon, Br₂:Ar from 0:54 to 12:42. The reactor is a quartz tube 50 cm in length and 0.67 cm inside diameter heated to between 850° C. to 1200° C. The reactant gases were monitored by mass spectrometry after passing through a 20% NaOH trap. The data is plotted in FIG. 13 showing methane conversion over the temperature range and the hydrogen yield for a methane to bromine mole ratio of 1 in comparison to methane alone. No thermal reaction of methane is observed at 850° C., however, in the bromine mediated reaction, conversion occurs even at this low temperature with both hydrogen and hydrogen bromide observer. As the temperature is increase further, methane conversion is observed together with additional hydrogen yield.

### Example 2

### Methane Conversion to Hydrogen and Hydrogen Halide and Carbon

In another specific example, methane is converted into solid carbon in a semi-batch reactor containing porous carbon with 50% void fraction. The reactor is a quartz tube with 50 cm in length and 0.67 cm inside diameter heated 1150° C. with a feed of 6 sccm methane and 54 sccm of varying molar ratios of bromine and argon, Br₂:Ar from 0:54 to 12:42. The solid carbon produced was deposited on the porous carbon packing and the product gases monitored by mass spectrometry after passing through a 20% NaOH trap. At 1150° C. and an approximately 4 second gas residence time, a reasonably high methane conversion is observed without bromine. As the bromine mole ratio is increased (from 0.5 to 2), the methane conversion approaches 100% and the hydrogen yield increases to the stoichiometric value of 1.

### Example 3

### Production of Halogen-Free Carbon

In another specific example, methane is reacted with bromine and converted into solid carbon in a semi-batch reactor containing porous graphite with a heated void fraction of 50%. The reactor is a quartz tube with 50 cm in length and 0.67 cm inside diameter heated 1190° C. with a feed of 6 sccm methane, 6 sccm bromine and 48 sccm Ar. The solid carbon produced was deposited on the porous carbon packing and the product gases monitored by mass spectrometry after passing through a 20% NaOH trap. At 1190° C. and an approximately 4 second gas residence time, the reactor was operated for 2 hours with methane conversion of 100%. After that, the feed was switched to pure hydrogen for 1 hour and then cooled to room temperature. The carbon was analyzed using electron microscopy with elemental analysis by energy dispersive x-ray analysis and no residual bromine was detected in the carbon.

### Example 4

### Production of Halogen-Free Carbon

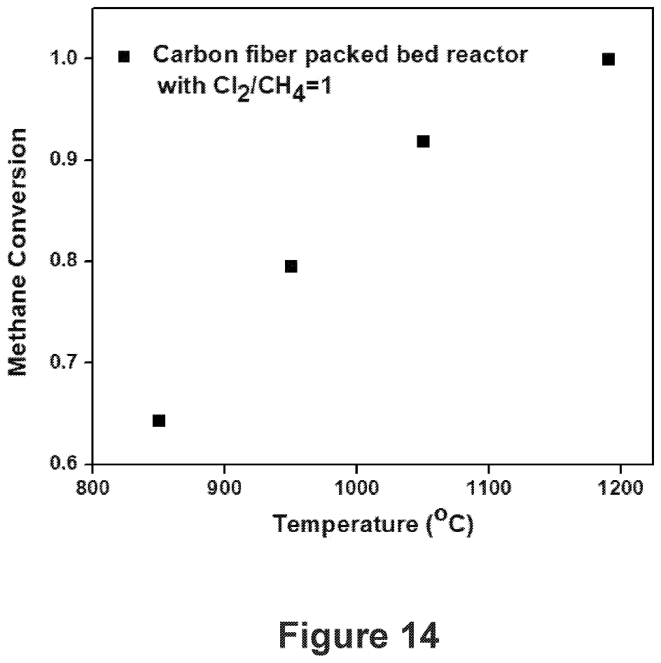

In another specific example, methane is reacted with a chlorination agent (carbon tetrachloride) and converted into solid carbon in a semi-batch reactor containing porous graphite with a heated void fraction of 50%. The reactor is a quartz tube with 50 cm in length and 0.67 cm inside diameter heated 1190° C. with a feed of 6 sccm methane, 3 sccm carbon tetrachloride and 51 sccm Ar. The solid carbon produced was deposited on the porous carbon packing and the product gases monitored by mass spectrometry after passing through a 20% NaOH trap. FIG. 14 shows the increasing methane conversion for increasing temperatures up to 1190° C. At 1190° C. and an approximately 4 second gas residence time, the reactor was operated for 2 hours with methane conversion of 100%. After that, the feed was switched to pure hydrogen for 1 hour and then cooled to room temperature. The carbon was analyzed electron microscopy with elemental analysis by energy dispersive x-ray analysis and no residual chlorine was detected in the carbon.

### Example 5

Continuous Generation of Hydrogen and Hydrogen Halide from Halogen Mediated Pyrolysis of a Crude Oil Component

In a specific example of pyrolysis of hydrocarbons such as crude oil, 20 sccm of normal octane vapor was contacted with chlorine gas at a molar ratio of Cl₂:C₈H₁₈ of 2:1 in a plug flow reactor maintained at 1000° C. The gas residence time was 6 seconds. 100% conversion of both reactants was observed with the hydrogen products detected by mass spectroscopy and the HCl detected in a bubbler where the pH was measured. The detected products were consistent with a molar ratio of H₂:HCl of 7:4 which is the stoichiometric yield. The amorphous carbon product had no detectable chlorine by energy dispersive x-ray analysis.

### Example 6

### Production of Halogen-Free Carbon

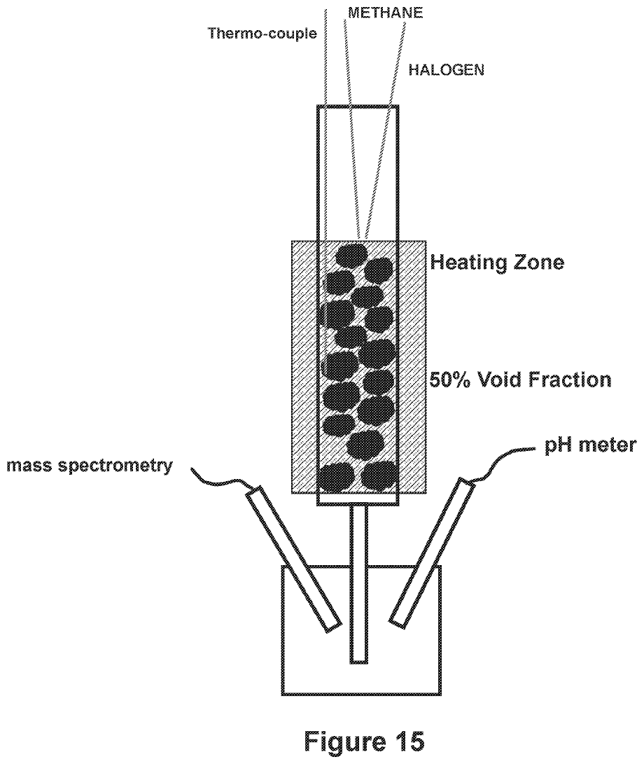

In another specific example shown schematically in FIG. 15, methane is contacted with a chlorination agent (carbon tetrachloride) within the reactor and converted into solid carbon in a semi-batch reactor containing porous graphite packing with a heated void fraction of 50%. The carbon bed is 13 cm length and 2 cm inside diameter. Before the reaction, the carbon was reduced by H₂ at 1100° C. to clean up the surface hydroxy group. Then a mixture of 12 sccm methane, 6 sccm CCl₄ and 32 sccm Ar was fed into the reactor at 1100° C. Methane and H₂ were monitored and quantified by mass spectrometry. The produced HCl was trap by DI water and quantified by measuring the pH value of water (the pH meter was calibrated by injected known amount of HCl into water beforehand). At 1100° C. and approximately 10 second gas residence time, methane showed 97% conversion. After that, the feed was switched to pure hydrogen for 1 hour and then cooled to room temperature. The carbon was analyzed electron microscopy with elemental analysis by energy dispersive x-ray analysis and no residual chlorine was detected in the carbon.

Having described various systems and methods, certain aspect can include, but are not limited to:

In a first aspect, embodiments of which are illustrated in FIGS. 1A and 1B, a process for producing hydrogen from feedstocks containing hydrogen and carbon comprises: contacting a hydrocarbon feedstock with a reactant containing a halogen in a reactor to produce hydrogen, hydrogen halide, and a solid product, wherein the solid product comprises carbon; regenerating the halogen from the hydrogen halide; and separating the hydrogen as a product.

A second aspect can include the process of the first aspect, embodiments of which are illustrated in FIG. 1B, further comprising: separating the solid product from the hydrogen and hydrogen halide in the reactor.

A third aspect can include the process of the second aspect, further comprising: separating the solid product from the hydrogen and hydrogen halide in a separator downstream of the reactor.

A fourth aspect can include the process of any one of the first to third aspects, where the regeneration of the halogen occurs without the presence of oxygen.

A fifth aspect can include the process of any one of the first to third aspects, wherein regeneration of the halide comprises: contacting the hydrogen halide with oxygen to generate water and the halogen; and separating the halogen from the water.

A sixth aspect can include the process of any one of the first to fifth aspects, further comprising: separating the hydrogen halide from the hydrogen; and storing the hydrogen halide in a hydrogen halide storage, wherein regenerating the halogen from the hydrogen halide comprises using at least a portion of the hydrogen halide storage.

A seventh aspect can include the process of the sixth aspect, further comprising: using renewable energy to regenerate at least a portion of the halogen from the hydrogen halide; and storing the halogen in a halogen storage, wherein at least a portion of the halogen in the storage is recycled and contacted with the hydrocarbon feedstock in the reactor.

An eighth aspect can include the process of any one of the first to seventh aspects, further comprising: introducing the hydrocarbon feedstock into the reactor separately from the halogen.

A ninth aspect can include the process of any one of the first to eighth aspects, further comprising: pre-heating the halogen prior to contacting the halogen with the hydrocarbon feedstock in the reactor.

A tenth aspect can include the process of the ninth aspect, wherein pre-heating the halogen comprises passing the halogen through a molten salt outside of the presence of the hydrocarbon feedstock.

An eleventh aspect can include the process of any one of the first to tenth aspects, wherein contacting the hydrocarbon feedstock with the halogen occurs at a temperature between about 600-1300° C.

A twelfth aspect can include the process of any one of the first to eleventh aspects, wherein the solid product is substantially free of the halogen.

A thirteenth aspect can include the process of any one of the first to twelfth aspects, wherein the hydrocarbon feedstock comprises at least one of natural gas, crude oil, vapors from petroleum, or other hydrocarbons.

A fourteenth aspect can include the process of any one of the first to thirteenth aspects, wherein the halogen comprises one or more of an elemental halogen, fluorine, chlorine, bromine, iodine, an alkyl a metal halide, or a hydrogen halide.

A fifteenth aspect can include the process of any one of the first to fourteenth aspects, wherein regenerating the halogen comprises electrochemically converting the hydrogen halide to produce the halogen and molecular hydrogen.

A sixteenth aspect can include the process of any one of the first to fourteenth aspects, wherein regenerating the halogen comprises recovering the halogen by reacting the hydrogen halide with a substance to produce another substance that when heated decomposes and produces the halogen by thermochemical looping.

A seventeenth aspect can include the process of any one of the first to fourteenth aspects, wherein regenerating the halogen comprises recovering the halogen by reacting the hydrogen halide with oxygen with or without a catalyst to produce the halogen and water in an exothermic reaction.

An eighteenth aspect can include the process of any one of the first to seventeenth aspects, wherein the feedstock comprises primarily methane, wherein a molar ratio of the methane:halogen is between 10:1 and 1:2, wherein the reactor is operated at a temperature between 650-1700° C. and a pressure between 1 bar and 100 bar.

A nineteenth aspect can include the process of any one of the first to eighteenth aspects, further comprising: separating a hydrocarbon stream into a plurality of fractions; contact one or more of the plurality of fractions with the halogen to produce monohalides and polyhalides, wherein the polyhalides are configured to pass to the reactor as at least a portion of the hydrocarbon feedstock; and generating one or more products from the monohalides.

In a twentieth aspect, embodiments of which are illustrated in FIG. 1A-1B or 3, a pyrolysis system using a halogen comprises a reactor (e.g., 5′ in FIG. 1A or 5 in FIG. 3), wherein the reactor is configured to contact a hydrocarbon feedstock with a reactant containing a halogen to produce hydrogen, hydrogen halide, and a solid product, wherein the solid product comprises carbon; a halogen regeneration unit (e.g. 8′ in FIG. 1A or 8 in FIG. 3), wherein the halogen regeneration unit is configured to receive at least a portion of the hydrogen halide from the reactor and generate the halogen; and a recycle line (e.g., 2′ in FIG. 1A) fluidly coupling the reactor and the halogen regeneration unit configured to pass at least a portion of the halogen from the halogen regeneration unit to the reactor.

A twenty first aspect can include the system of the twentieth aspect, further comprising: a separator (e.g. 7′ in FIG. 1A or 7 in FIG. 3) fluidly connected between the reactor and the halogen regeneration unit, wherein the separator is configured to separate the solid product from the hydrogen and hydrogen halide.

A twenty second aspect can include the system of the twentieth or twenty first aspect, further comprising: a hydrogen halide storage (e.g., 31 in FIG. 3) fluidly connected with the reactor and the halogen regeneration unit, wherein the hydrogen halide storage is configured to store at least a portion of the hydrogen halide formed in the reactor.

A twenty third aspect can include the system of any one of the twentieth to twenty second aspects, further comprising: a halogen storage (e.g., 32 in FIG. 3) fluidly coupled to the halogen regeneration unit, wherein the halogen storage is configured to store at least a portion of the halogen.

A twenty fourth aspect can include the system of the twenty second or twenty third aspect, further comprising: a renewable energy source, wherein the renewable energy source is configured to provide power to at least one of the halogen regeneration unit, the halogen halide storage, or the halogen storage.

A twenty fifth aspect can include the system of any one of the twentieth to twenty fourth aspects, further comprising: a halogen heater (e.g., 4 in FIG. 3), wherein the halogen heater is configured to heat the halogen prior to the halogen passing into the reactor.

A twenty sixth aspect can include the system of the twenty fifth sapect, wherein the halogen heater comprises a molten salt heater.

A twenty seventh aspect can include the system of any one of the twentieth to twenty sixth aspects, wherein the halogen regeneration unit comprises an electrolyzer or a reactor.

A twenty eighth aspect can include the system of any one of the twentieth to twenty seventh aspects, further comprising: a hydrocarbon separator (e.g., 55 in FIG. 5), wherein the hydrocarbon separator is configured to separate the hydrocarbon feedstock into a plurality of fractions; a halogenation reactor (e.g. 54 in FIG. 5), wherein the halogenation reactor is configured to contact one or more of the plurality of fractions with the halogen to produce monohalides and polyhalides, wherein the polyhalides are configured to pass to the reactor; a product reactor, wherein the product reactor is configured to receive at least a portion of the monohalides and generate a portion of the hydrogen halide and one or more products from the monohalides.

In a twenty ninth aspect, an embodiment of which is illustrated in FIG. 11) a reaction process comprises: introducing a hydrocarbon feedstock into a reactor countercurrent to a moving bed of solid material moving through a reaction zone in the reactor; introducing a halogen into the feedstock within the reactor to contact the halogen with the hydrocarbon feedstock; producing solid products, hydrogen, and hydrogen halide in response to contacting the halogen with the hydrocarbon feedstock; depositing the solid products on the moving bed of the solid material; and passing the hydrogen and hydrogen halide out of the reactor.

A thirtieth aspect can include the process of the twenty ninth aspect, further comprising: introducing the solid material at lower temperature than a temperature in the reaction zone; heating the solid material upstream of the reaction zone using the hydrogen and hydrogen halide moving counter-currently to the solid material; cooling the hydrogen and hydrogen halide based on heating the solid material upstream of the reaction zone.

A thirty first aspect can include the process of the twenty ninth or thirtieth aspect, further comprising: separating the hydrogen halide from the hydrogen; and regenerating the halogen from the hydrogen halide using either electrochemical or thermochemical processes.

A thirty second aspect can include the process of any one of the twenty ninth to thirty first aspects, further comprising: pre-heating the halogen prior to introducing the halogen into the hydrocarbon feedstock.

A thirty third aspect can include the process of the thirty second aspect, wherein pre-heating the halogen comprises passing the halogen through a molten salt outside of the presence of the hydrocarbon feedstock.

A thirty fourth aspect can include the process of any one of the twenty ninth to thirty third aspects, wherein the reaction zone has a temperature between about 600-1300° C.

A thirty fifth aspect can include the process of any one of the twenty ninth to thirty fourth aspects, wherein the solid product is substantially free of the halogen.

A thirty sixth aspect can include the process of any one of the twenty ninth to thirty fifth aspects, wherein the hydrocarbon feedstock comprises at least one of natural gas, crude oil, vapors from petroleum, or other hydrocarbons.

A thirty seventh aspect can include the process of any one of the twenty ninth to thirty sixth aspects, wherein the halogen comprises one or more of an elemental halogen, fluorine, chlorine, bromine, iodine, an alkyl a metal halide, or a hydrogen halide.

A thirty eighth aspect can include the process of any one of the twenty ninth to thirty seventh aspects, wherein the hydrocarbon feedstock comprises primarily methane, wherein a molar ratio of the methane:halogen in the reaction zone is between 10:1 and 1:2, wherein the reaction zone is operated at a temperature between 650-1700° C. and a pressure between 1 bar and 100 bar.

In a thirty ninth aspect, an embodiment of which is illustrated in FIG. 4, a reaction process comprises: passing a mixture of a hydrocarbon feedstock and a halogen through a first reactor bed; producing hydrogen, hydrogen halide, and a solid product within the first reactor bed, wherein the solid product deposits in the first reactor bed; passing the hydrogen and the hydrogen halide through a second reactor bed; heating the second reactor bed with the hydrogen and hydrogen halide; and passing the hydrogen and hydrogen halide to a separator.

A fortieth aspect can include the reaction process of the thirty ninth aspect, further comprising: passing the hydrogen and hydrogen halide from the second reactor bed to a third reactor bed; and heating the third reactor bed with the hydrogen and hydrogen halide from the second reactor bed.

A forty first aspect can include the reaction process of the thirty ninth or fortieth aspect, further comprising: isolating the first reactor bed from the hydrocarbon feedstock and the halogen; passing an amount of hydrogen through the first reactor bed; and removing the any residual halide from the solid product in the first reactor bed.

A forty second aspect can include the reaction process of the forty first aspect, further comprising: cooling the first reactor bed after passing the hydrogen through the first reactor bed.

A forty third aspect can include the reaction process of the forty second aspect, further comprising: removing at least a portion of the solid product from the first reaction bed after cooling the first reactor bed.

A forty fourth aspect can include the reaction process of the forty third aspect, further comprising: reintroducing the hydrocarbon feedstock and the halogen to the first reactor bed after removing at least a portion of the solid product from the first reactor bed.

A forty fifth aspect can include the reaction process of the thirty ninth or fortieth aspect, wherein the first reactor bed has a temperature between about 600-1300° C.

A forty sixth aspect can include the reaction process of any one of the thirty ninth to forty fifth aspects, wherein the hydrocarbon feedstock comprises at least one of natural gas, crude oil, vapors from petroleum, or other hydrocarbons.

A forty seventh aspect can include the reaction process of any one of the thirty ninth to forty sixth aspects, wherein the halogen comprises one or more of an elemental halogen, fluorine, chlorine, bromine, iodine, an alkyl a metal halide, or a hydrogen halide.

In a forty eighth aspect, an embodiment of which is illustrated in FIG. 7, a process of recovering hydrogen from a subterranean formation comprises: injecting a halogen into a subterranean formation, wherein the subterranean formation comprises a hydrocarbon; contacting the halogen with the hydrocarbon in the subterranean formation; producing hydrogen, hydrogen halide, and a solid product, wherein the solid product comprises carbon; depositing the carbon in the subterranean formation; and recovering the hydrogen and hydrogen halide from the subterranean formation.

A forty ninth aspect can include the process of the forty eighth aspect, wherein injecting the halogen comprises injecting the halogen using a first wellbore, and wherein recovering the hydrogen and hydrogen halide comprises using a second wellbore in the subterranean formation.

A fiftieth aspect can include the process of the forty eighth or forty ninth aspect, further comprising: regenerating the halogen from the hydrogen halide recovered from the subterranean formation; and recycling at least a portion of the regenerated halogen to the subterranean formation as a portion of the halogen.

A fifty first aspect can include the process of the fiftieth aspect, where the regenerating of the halogen occurs without the presence of oxygen.

A fifty second aspect can include the process of any one of the forty eighth to fifty first aspects, wherein regeneration of the halogen comprises: contacting the hydrogen halide with oxygen to generate water and the halogen; and separating the halogen from the water.

A fifty third aspect can include the process of any one of the forty eighth to fifty second aspects, wherein the halogen comprises one or more of an elemental halogen, fluorine, chlorine, bromine, iodine, an alkyl a metal halide, or a hydrogen halide.

A fifty fourth aspect can include the process of any one of the forty eighth to fifty third aspects, wherein the subterranean formation comprises oil or shale comprising the hydrocarbon.

A fifty fifth aspect can include the process of the twenty ninth or thirty ninth aspects, performed using a reactor comprising the moving bed or the first reactor bed, wherein moving bed or the first reactor bed comprises a packing or packed bed optionally comprising solid carbon or porous carbon.

A fifty sixth aspect can include the process of the seventh or twenty fourth aspect, wherein the renewable energy is used to power the regenerating and the storing of the halogen so as to enable continuous operation of the reactor producing hydrogen, hydrogen halide, and the solid product using the halogen even when no power is available.

A fifty seventh aspect can include the process or system of any of the first to fifty sixth aspects, wherein the steps of the process or components of the system are integrated at the same facility.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

The invention claimed is:

1. A process for producing hydrogen from feedstocks containing hydrogen and carbon comprising the following steps:
contacting a hydrocarbon feedstock with a reactant containing a halogen in a reactor to produce hydrogen, hydrogen halide, and a solid product, wherein the solid product comprises carbon;
regenerating the halogen from the hydrogen halide; and
separating the hydrogen as a product.

2. (canceled)

3. The process of claim 1, where the regeneration of the halogen occurs without the presence of oxygen.

4. The process of claim 1, wherein regeneration of the halide comprises:
contacting the hydrogen halide with oxygen to generate water and the halogen; and
separating the halogen from the water.

5. The process of claim 1, further comprising:
separating the hydrogen halide from the hydrogen; and
storing the hydrogen halide in a hydrogen halide storage, wherein regenerating the halogen from the hydrogen halide comprises using at least a portion of the hydrogen halide storage,
using renewable energy to regenerate at least a portion of the halogen from the hydrogen halide; and
storing the halogen in a halogen storage, wherein at least a portion of the halogen in the storage is recycled and contacted with the hydrocarbon feedstock in the reactor.

6. (canceled)

7. The process of claim 1, further comprising:
introducing the hydrocarbon feedstock into the reactor separately from the halogen; and
pre-heating the halogen prior to contacting the halogen with the hydrocarbon feedstock in the reactor, wherein pre-heating the halogen comprises passing the halogen through a molten salt outside of the presence of the hydrocarbon feedstock.

8. (canceled)

9. The process of claim 1, wherein contacting the hydrocarbon feedstock with the halogen occurs at a temperature between about 600-1300° C.

10. The process of claim 1, wherein the hydrocarbon feedstock comprises at least one of natural gas, crude oil, vapors from petroleum, or other hydrocarbons, and wherein the halogen comprises one or more of an elemental halogen, fluorine, chlorine, bromine, iodine, an alkyl a metal halide, or a hydrogen halide.

11. The process of claim 1, wherein regenerating the halogen comprises at least one of: electrochemically converting the hydrogen halide to produce the halogen and molecular hydrogen, recovering the halogen by reacting the hydrogen halide with a substance to produce another substance that when heated decomposes and produces the halogen by thermochemical looping, or recovering the halogen by reacting the hydrogen halide with oxygen with or without a catalyst to produce the halogen and water in an exothermic reaction.

12. The process of claim 1, wherein the feedstock comprises primarily methane, wherein a molar ratio of the methane:halogen is between 10:1 and 1:2, wherein the reactor is operated at a temperature between 650-1700° C. and a pressure between 1 bar and 100 bar.

13. The process of claim 1, further comprising:
separating a hydrocarbon stream into a plurality of fractions;
contact one or more of the plurality of fractions with the halogen to produce monohalides and polyhalides, wherein the polyhalides are configured to pass to the reactor as at least a portion of the hydrocarbon feedstock; and
generating one or more products from the monohalides.

14. A pyrolysis system using a halogen, the system comprising:
a reactor, wherein the reactor is configured to contact a hydrocarbon feedstock with a reactant containing a halogen to produce hydrogen, hydrogen halide, and a solid product, wherein the solid product comprises carbon;
a halogen regeneration unit, wherein the halogen regeneration unit is configured to receive at least a portion of the hydrogen halide from the reactor and generate the halogen; and
a recycle line fluidly coupling the reactor and the halogen regeneration unit configured to pass at least a portion of the halogen from the halogen regeneration unit to the reactor.

15. The system of claim 14, further comprising:
a separator fluidly connected between the reactor and the halogen regeneration unit, wherein the separator is configured to separate the solid product from the hydrogen and hydrogen halide.

16. The system of claim 14, further comprising:
a hydrogen halide storage fluidly connected with the reactor and the halogen regeneration unit, wherein the hydrogen halide storage is configured to store at least a portion of the hydrogen halide formed in the reactor;
a halogen storage fluidly coupled to the halogen regeneration unit, wherein the halogen storage is configured to store at least a portion of the halogen;
a renewable energy source, wherein the renewable energy source is configured to provide power to at least one of the halogen regeneration unit, the halogen halide storage, or the halogen storage.

17.-19. (canceled)

20. The system of claim 14, further comprising:
a hydrocarbon separator, wherein the hydrocarbon separator is configured to separate the hydrocarbon feedstock into a plurality of fractions;
a halogenation reactor, wherein the halogenation reactor is configured to contact one or more of the plurality of fractions with the halogen to produce monohalides and polyhalides, wherein the polyhalides are configured to pass to the reactor;
a product reactor, wherein the product reactor is configured to receive at least a portion of the monohalides and generate a portion of the hydrogen halide and one or more products from the monohalides.

21. A reaction process comprising:
introducing a hydrocarbon feedstock into a reactor countercurrent to a moving bed of solid material moving through a reaction zone in the reactor;
introducing a halogen into the feedstock within the reactor to contact the halogen with the hydrocarbon feedstock;
producing solid products, hydrogen, and hydrogen halide in response to contacting the halogen with the hydrocarbon feedstock;
depositing the solid products on the moving bed of the solid material; and
passing the hydrogen and hydrogen halide out of the reactor.

22. The process of claim 21, further comprising:
introducing the solid material at lower temperature than a temperature in the reaction zone;
heating the solid material upstream of the reaction zone using the hydrogen and hydrogen halide moving counter-currently to the solid material;
cooling the hydrogen and hydrogen halide based on heating the solid material upstream of the reaction zone;
separating the hydrogen halide from the hydrogen; and
regenerating the halogen from the hydrogen halide using either electrochemical or thermochemical processes.

23. (canceled)

24. The process of claim 21, wherein the hydrocarbon feedstock comprises at least one of natural gas, crude oil, vapors from petroleum, or other hydrocarbons, and wherein the halogen comprises one or more of an elemental halogen, fluorine, chlorine, bromine, iodine, an alkyl a metal halide, or a hydrogen halide.

25. The process of claim 21, wherein the hydrocarbon feedstock comprises primarily methane, wherein a molar ratio of the methane:halogen in the reaction zone is between 10:1 and 1:2, wherein the reaction zone is operated at a temperature between 650-1700° C. and a pressure between 1 bar and 100 bar.

26. The process of claim 21, wherein the reaction zone comprises a first reactor bed and a second reactor bed, wherein introducing the hydrocarbon feedstock into the reactor, introducing the halogen into the feedstock, and producing the solid products, the hydrogen, and the hydrocarbon halide comprise:
passing a mixture of the hydrocarbon feedstock and the halogen through the first reactor bed;
producing the hydrogen, the hydrogen halide, and the solid product within the first reactor bed, wherein the solid product deposits in the first reactor bed;
passing the hydrogen and the hydrogen halide through a second reactor bed;
heating the second reactor bed with the hydrogen and hydrogen halide; and
passing the hydrogen and hydrogen halide to a separator.

27. The reaction process of claim 26, further comprising:
passing the hydrogen and hydrogen halide from the second reactor bed to a third reactor bed;
heating the third reactor bed with the hydrogen and hydrogen halide from the second reactor bed;
isolating the first reactor bed from the hydrocarbon feedstock and the halogen;
passing an amount of hydrogen through the first reactor bed; and
removing the any residual halide from the solid product in the first reactor bed.

28.-35. (canceled)
